(19) United States
(12) Patent Application Publication
(10) Pub. No.: US 2009/0020425 A1
(43) Pub. Date: Jan. 22, 2009

(54) GAS SENSOR

(75) Inventor: Kouhei YAMADA, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/175,030

(22) Filed: Jul. 17, 2008

(30) Foreign Application Priority Data
Jul. 18, 2007 (JP) 2007-186781

(51) Int. Cl. G01N 27/26

(52) U.S. Cl. 204/426

(57) ABSTRACT

The gas sensor includes a gas sensor element, a housing accommodating the gas sensor element, and an element cover fixed to the housing. The element cover includes an inner cover, and an outer cover. The outer cover is formed with outer openings at a side surface thereof, and includes a front end portion formed with a discharge opening, the discharge opening being located more closely to the front end side than the outer openings. The inner cover is formed with inner openings at a side surface thereof, the inner openings being located more closely to the front end side than the outer openings. When a clearance between the outer and inner covers at a longitudinal position of the outer openings is A, and an inner diameter of the outer cover at this longitudinal position is B, a ratio of A/B is set equal to or larger than a predetermined value.

### CROSS-REFERENCE TO RELATED APPLICATION

This application is related to Japanese Patent Application No. 2007-186781 filed on Jul. 18, 2007, the contents of which are hereby incorporated by reference.

### BACKGROUND OF THE INVENTION

1. Field of the Invention

The present invention relates to a gas sensor mounted on an exhaust system or the like of an internal engine to measure a concentration of a specific gas contained in a gas under measurement.

2. Description of Related Art

To perform combustion control of an internal combustion engine such as a vehicle engine on the basis of an air-fuel ratio of the engine, as shown in FIG. 8, it is known to provide an exhaust system of the engine with a gas sensor 9 which measures an oxygen concentration in the exhaust gas G, and determines the air-fuel ratio from the oxygen concentration measured by the gas sensor 9. The gas sensor 9 includes therein a gas sensor element 92 constituted by a solid electrolyte body made of zirconia, for example, and an element cover 93 covering the gas sensor element 92. The element cover 93 is made of metal such as stainless steel, and formed with vent holes 933 allowing the exhaust gas G to pass therethrough.

The exhaust gas G flowing through an exhaust pipe of the exhaust system enters inside the element cover 93 through the vent holes 933, and reaches the gas sensor element 92. By the exhaust gas G contacting the gas sensor element 92, it is possible to measure an oxygen concentration in the exhaust gas G. Incidentally, when the engine is cold-started, it may occur that moisture contained in the exhaust gas G is condensed to waterdrops when it contacts an inner wall surface of the cold exhaust pipe. If the engine is started up in this state, the waterdrops are blown off the inner wall surface and enters inside the element cover 93 together with the exhaust gas G, particularly during a period in which the temperature of the exhaust gas G is still low, and accordingly the waterdrops are not vaporized.

On the other hand, for the gas sensor element 92 to perform measurement, it is necessary to keep the gas sensor element 92 constituted by a solid electrolyte body at a high temperature, higher than 400 degrees C. so that it is kept in an active state. Accordingly, if the waterdrops W which have entered inside the element cover 93 adhere to a surface of the gas sensor element 92, cracks may occur in the gas sensor element 92 due to thermal shock.

To cope with this problem, in the system shown in FIG. 8, the gas sensor 9 has a double-covered structure in which the element cover 93 is constituted by an inner cover 931 and an outer cover 932, and the vent holes 933 are formed so as not to overlap in the direction of flow of the exhaust gas G, in order to prevent adherence of the waterdrops W to the gas sensor element 92. However, if the waterdrops W adheres to an outer surface 934 of the outer cover 932, they move on the outer surface 934 until they reach the vent hole 933 of the outer cover 932, and enter inside the outer cover 932. These waterdrops W may move on an outer surface 934 of the inner cover 931 or an inner surface 935 of the outer cover 932 until they reach the vent hole 933 of the inner cover 931, and enter inside the inner cover 931.

If this happens, cracks may occur in the gas sensor element 92 due to the waterdrops W adhering to the gas sensor element 92.

To cope with this problem, as shown in FIG. 9, there is known a technique in which the gas sensor element 92 itself is provided with a water-repellent protection layer 94 to prevent the waterdrops W from adhering to the gas sensor element 92. For more details, refer to Japanese Patent Application Laid-open No. 8-240559. However, this technique has a problem in that since the time needed for the exhaust gas to be measured to reach a sensing portion of the gas sensor element 92 becomes long due to provision of the water-repellent protection layer 94, the response of the gas sensor 9 is lowered. In addition, since the thermal capacity of the gas sensor element 92 increases, also the time needed for the gas sensor element 92 to enter the active state becomes long. Furthermore, when a clearance between the outer cover 932 and the inner cover 931 is not large enough, the gas to be measured cannot be introduced inside the inner cover 931 in a sufficient quantity.

As shown in FIG. 10, it is also known that a gas sensor 90 is provided with a protection layer 940 formed so as to cover each of the vent holes 933. For more details, refer to Japanese Utility Model Application Laid-open No. 4-11461. However, there is another issue to be addressed with the gas sensor 90, the issue being that it takes a long time for the exhaust gas to be measured to reach a sensing portion of a gas sensor element 920, which results in a lowering of the gas sensor 90's response time.

### SUMMARY OF THE INVENTION

The present invention provides a gas sensor comprising:

a gas sensor element for measuring a concentration of a specific gas contained in a measurement gas;

a housing through which the gas sensor element is inserted in a longitudinal direction of the gas sensor; and

an element cover fixed to a front end portion of the housing;

the element cover including an inner cover and an outer cover located around the inner cover,

the outer cover being formed with a plurality of outer openings at a side surface thereof, and including a front end portion formed with a discharge opening, the discharge opening being located more closely to a front end side of the gas sensor than the outer openings,

the inner cover being formed with a plurality of inner openings at a side surface thereof, the inner openings being located more closely to the front end side of the gas sensor than the outer openings,

an opening direction of each of the inner openings extending from an inner side to an outer side of the inner cover having a direction component extending in the longitudinal direction towards a base end side of the gas sensor,

wherein, when a clearance between the outer and inner covers at a longitudinal position of the outer openings is A, and an inner diameter of the outer cover at the longitudinal position is B, a ratio of A/B is equal to or larger than a predetermined value.

According to the present invention, it is possible to provide a gas sensor having a high response speed, and a capability of preventing cracks from occurring therein due to moisture contained in a measurement gas.

Other advantages and features of the invention will become apparent from the following description including the drawings and claims.

### BRIEF DESCRIPTION OF THE DRAWINGS

In the accompanying drawings:

FIG. 1 is a longitudinal cross-sectional view of a gas sensor according to a first embodiment of the invention;

FIG. 2 is a longitudinal cross-sectional view of a gas sensor of an element cover of the gas sensor;

FIG. 3 is a perspective view of an inner cover of the gas sensor;

FIG. 4 is a longitudinal cross-sectional view of an element cover of a gas sensor according to a second embodiment of the invention;

FIG. 5 is a diagram explaining a method of evaluating a response characteristic of a gas sensor of the invention;

FIG. 6 is a graph showing measurements of the gains of gas sensors of the invention with respect to the value of A/B (the ratio of clearance A between the outer cover and the inner cover to the inner diameter B of the inner cover);

FIG. 7 is a graph showing measurements of the gains of gas sensors of the invention with respect to clearance A between the inner and outer covers;

FIG. 8 is a diagram explaining how cracks occur in a gas sensor element of a conventional gas sensor due to moisture contained in an exhaust gas;

FIG. 9 is a partial longitudinal cross-sectional view of a conventional gas sensor whose gas sensor element is coated with a protection layer; and

FIG. 10 is a partial longitudinal cross-sectional view of a conventional gas sensor whose vent holes are covered by a protection layer.

### PREFERRED EMBODIMENTS OF THE INVENTION

### First Embodiment

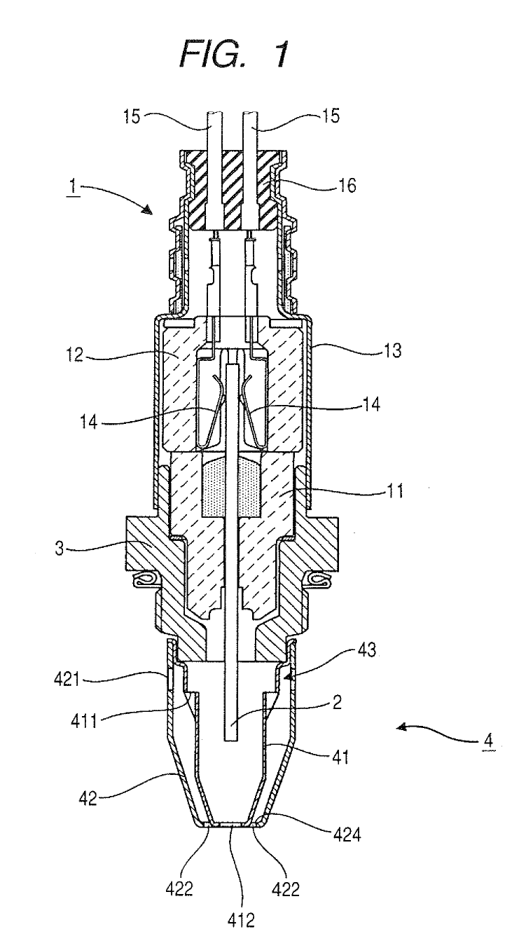

As shown in FIG. 1, a gas sensor 1 of a first embodiment of the invention includes a gas sensor element 2 for measuring a concentration of a specific gas contained in a gas under measurement, a housing 3 through which the gas sensor element 2 is inserted, and an element cover 4 fixed to a front end side of the housing 3. In this description, “front end” means a longitudinal end of the gas sensor 1 inserted into a pipe through which a measurement gas flows, and “base end” means the other longitudinal end of the gas sensor 1.

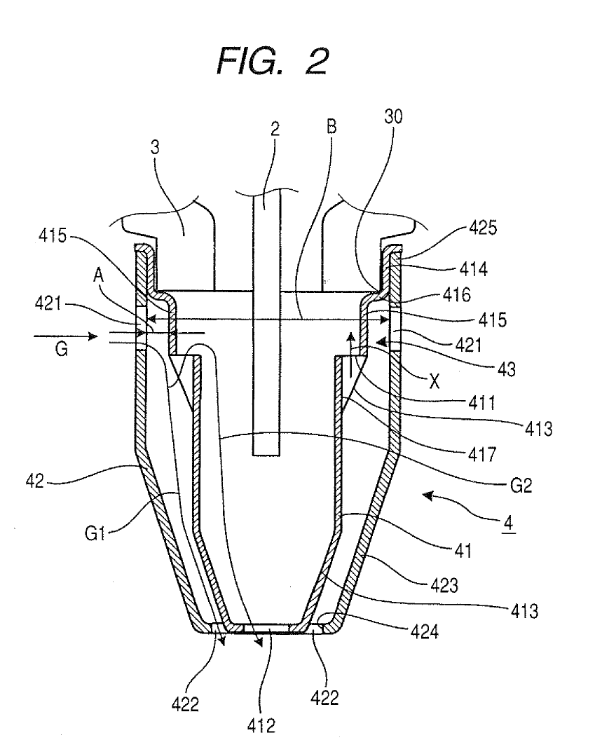

As shown in FIGS. 1 and 2, the element cover 4 includes an inner cover 41 and an outer cover 42 located around the inner cover 41. The outer cover 42 is formed with a plurality of outer openings 421 and a discharge opening 422 located more closely to the front end than the outer openings 421.

As shown in FIGS. 1 and 2, the inner cover 41 is formed with a plurality of inner openings 411 located more closely to the front end than the outer openings 421. A sensing portion of the gas sensor element 2 is located more closely to the front end than the inner openings 411. The inner openings 411 are formed such that the direction perpendicular to the opening plane thereof, which extends from the outside to the inside of the inner cover 411 (referred to as “opening direction X” hereinafter), includes a direction component which is parallel to the longitudinal axis of the gas sensor 1, and extends to the base end of the gas sensor 1. In this embodiment, the opening direction X of the inner openings 411 is parallel to the longitudinal axis of the gas sensor 1.

When the distance of a clearance 43 between the outer cover 42 and the inner cover 41 at a longitudinal position of the outer openings 421 is A, and an inner diameter of the outer cover 42 at the same longitudinal position is B, the relationship of A/B≧0.083 holds.

In this embodiment, the distance A is equal to or larger than 1 mm.

In the following, the gas sensor 1 of this embodiment is explained in more detail. As shown in FIGS. 1 and 2, the element cover 4 has the double cover structure in which the outer cover 42 is disposed around the inner cover 41. The outer cover 42 is formed with the outer openings 421. The outer opening 421 may be formed at 8 positions when it has a diameter of 1.5 mm, for example. The outer cover 42 includes an outer diameter-varying portion 423 having a tapered shape in which the diameter thereof reduces towards the front end side.

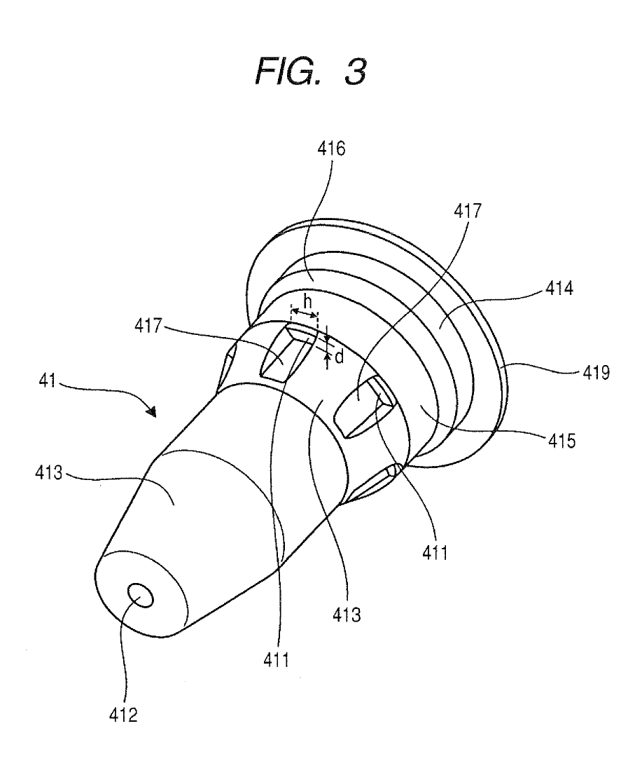

The inner cover 42 includes a first inner diameter-varying portion 413a located on the front end side, and a second inner diameter-varying portion 413b located on the base end side, each having a tapered shape in which the diameter thereof reduces towards the front end side. As shown in FIGS. 2 and 3, the second inner diameter-varying portion 413b is formed with a plurality of recessed portions 417. The inner openings 411 are formed by boring a hole in the base end portion of each of the recessed portions 417. Accordingly, the inner opening 411 has a louver-like configuration. The inner opening 411 may be formed at 6 positions when its width h in the circumferential direction of the gas sensor 1 is 2 mm, and its depth d in the radial direction of the gas sensor is 0.5 mm.

The inner cover 41 includes a front end portion formed with a front end opening 412 which opens to the outside. The front end opening 412 may have a diameter of 2 mm. The inner cover 41 also includes an opposite side portion 415 formed so as to be opposite to the outer openings 421 and extend in parallel with the longitudinal axis of the gas sensor 1. The opposite side portion 415 is located more closely to the base end side of the gas sensor 1 than the first and second inner diameter-varying portions 413a and 413b.

The outer cover 42 includes a front end portion formed with a large-diameter opening 424 whose inner diameter (6 mm, for example) is larger than an outer diameter (5 mm, for example) of the front end portion of the inner cover 41. By inserting the front end portion of the inner cover 41 into the large-diameter opening 424, there is formed the discharge opening 422 having a width of 0.5 mm, for example, between an outer wall of the front end portion and an inner wall of the large-diameter opening 424.

The front end portion of the inner cover 41 may protrude from or recede from the front end portion of the outer cover 42. As shown in FIGS. 1 and 2, the inner cover 41 includes a base end fixing portion 414 at its base end side. The inner cover 41 is crimped to the housing 3 at this base end fixing portion 414. The base end fixing portion 414 has an inner diameter larger than that of the opposite side portion 415. The housing 3 abuts against a step portion 416 formed between the base end fixing portion 414 and the opposite side portion 415 at a front end angular portion 30 thereof. The outer cover 42 includes an outer fixing portion 425 at its base end side. The base end fixing portion 414 is crimped around the outer fixing portion 425. The housing 3 and the base end fixing portion 414 may be welded to each other. Also, the base end fixing portion 414 and the outer fixing portion 425 may be welded to each other.

As described above, in this embodiment, the distance A of the clearance 43 between the outer cover 42 and the inner cover 41 at the longitudinal position of the outer openings 421, and the inner diameter B of the outer cover 42 at the same longitudinal position are in the relationship of A/B≧0.083. As shown in FIG. 2, the distance A is a radial distance between the outer opening 421 and the opposite side portion 415, and the inner diameter B is an inner diameter of the outer cover 42 at the longitudinal position of the outer openings 421.

As shown in FIG. 1, inside the housing 3, an element side insulator 11 is held through which the gas sensor element 2 is inserted to be held. An atmosphere side insulator 12 is located at the base end side of the element side insulator 11. An atmosphere side cover 13 is located so as to cover the atmosphere side insulator 12. This atmosphere side cover 13 is fixed to a base end side of the housing 3. Inside the atmosphere side cover 13, metal terminals 14 for electrical connection to the gas sensor element 2 are held. Outer leads 15 connected to the metal terminals 14 are wired through a bushing 16 which closes a base end side of the atmosphere side cover 13.

The gas sensor element 2 includes a solid electrolyte body consisting primarily of zirconia at one surface thereof, and a reference gas side electrode and a measurement gas side electrode at the other surface thereof. The gas sensor element 2 also includes therein a heater. The heater heats the gas sensor element 2 at a high temperature of over 400 degrees C. to keep the gas sensor element 2 in an active state while the gas sensor 1 is in operation.

Next, the operation and advantages of the gas sensor 1 are explained. The element cover 4 is provided with the outer openings 421 and the discharge opening 422 at its outer cover 42, and provided with the inner openings 411 at its inner cover 41. The inner openings 411 are located more closely to the front end of the gas sensor 1 than the outer openings 421. Accordingly, as shown in FIG. 2, a measurement gas G flowing from the lateral side of the gas sensor 1 is introduced between the outer cover 42 and the inner cover 41 through the outer openings 421, and thereafter discharged from the discharge opening 422 (G1). Part of the measurement gas G introduced between the outer cover 42 and the inner cover 41 is further introduced into the inside of the inner cover 41, and reaches the gas sensor element 2 (G2).

As described above, the sensing portion of the gas sensor element 2 is located more closely to the front end than the inner openings 411, and the inner openings 411 are formed such that the opening direction X includes a direction component which is parallel to the longitudinal axis of the gas sensor 1, and extends to the base end of the gas sensor 1. Accordingly, of the flow of the measurement gas G introduced into the inside of the outer cover 42 through the outer openings 421, the flow G1 heading to the discharge opening 42 is flowing in a comparatively rectilinear flow, while, the flow G2 heading from the inner openings 411 to the inside of the inner cover 41 is flowing in a comparatively curvilinear flow.

Accordingly, waterdrops flowing together with the measurement gas and introduced between the outer cover 42 and the inner cover 41 head to the discharge opening 422 and are discharged therethrough due to inertial force. That is, since the waterdrops have a large specific gravity compared to the measurement gas, the waterdrops move along the rectilinear flow G1, and are discharged from the discharge opening 422. On the other hand, the measurement gas having a small specific gravity compared to the waterdrops can move along the curvilinear flow G2 to enter inside the inner cover 41 other than along the rectilinear flow G1.

This makes it possible to prevent the waterdrops contained in the measurement gas from entering inside the inner cover 41, to thereby prevent the gas sensor element 2 from being flooded. Accordingly, the gas sensor element 2 can be prevented from cracking due to moisture contained in the measurement gas.

In addition, since the outer openings 421 and the inner openings 411 are formed in such positions that the waterdrops are prevented from entering inside the inner cover 41, the measurement gas can be introduced inside the element cover 4 in a sufficient quantity. This makes it possible for the gas sensor 1 to have a high response characteristic. Furthermore, since the gas sensor element 2 is not provided with any protection layer at its surface, and accordingly, the time needed for the measurement gas to reach the sensing section of the gas sensor element 2 is not prolonged, there is no lowering of response speed of the gas sensor 1. Also, since there is not increase in the heat capacity of the gas sensor element 2 due to provision of a protection layer, the time needed for the gas sensor element 2 to enter an active state does not become long.

In the gas sensor 1, the distance A of the clearance 43 between the outer cover 42 and the inner cover 41 at the longitudinal position of the outer openings 421, and the inner diameter B of the outer cover 42 at the same longitudinal position are in the relationship of A/B≧0.083. This makes it possible for a sufficient amount of the measurement gas introduced between the outer cover 42 and the inner cover 41 to easily enter inside the inner cover 41 from the inner openings 411. Accordingly, the measurement gas flowing through an exhaust pipe or the like can be smoothly and sufficiently supplied to the gas sensor element 2. As a result, a time lag between the change of an air-fuel ratio and the change of a sensor output can be made sufficiently small, to thereby improve the response characteristic of the gas sensor 1.

Furthermore, the distance A of the clearance 43 is made 1 mm or longer. This also makes it possible to sufficiently introduce the measurement gas between the outer cover 42 and the inner cover 41. Accordingly, the response characteristic of the gas sensor 1 can be further improved.

### Second Embodiment

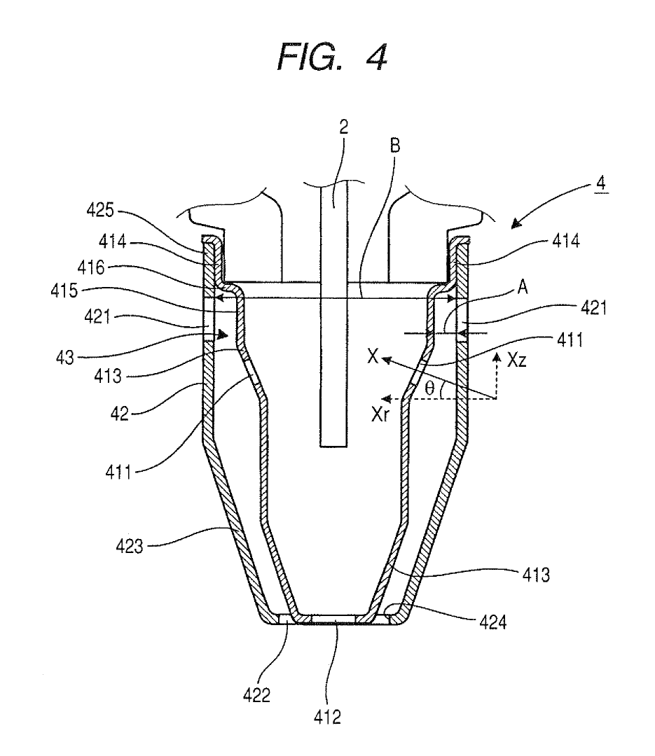

As shown in FIG. 4, the second embodiment differs from the first embodiment in that the recessed portions 417 are not provided, and the inner openings 411 are formed by boring holes in the second inner diameter-varying portions 413b. In this embodiment, the vector of the opening direction X includes a longitudinal direction component Xz and a radial direction component Xr, and the angle θ thereof with respect to the radial direction is larger than 17 degrees. Also in this embodiment, the relationship of A/B≧0.083 holds. As for the others, the second embodiment is the same as the first embodiment.

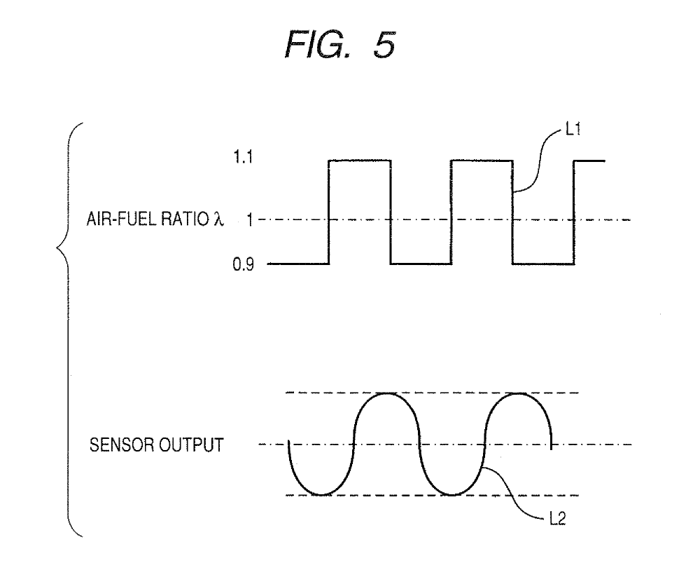

Next, results of evaluation on the response characteristic of the gas sensor of the invention are explained with reference to FIGS. 5 to 7. In this evaluation, the relationship between the response speed of the gas sensor 1 and the value of A/B was checked. Here, A/S is a ratio of the distance A of the clearance between the outer cover 42 and the inner cover 41 to the inner diameter B of the inner cover 42 at the longitudinal position of the outer openings 421. The response speed was measured for seven gas sensors of the invention having different values of A/B. These gas sensors have the same size and structure as the gas sensor 1 of the first embodiment except for the value of A/B.

The measurement was performed in the following manner. One of these gas sensors was mounted on an exhaust pipe of a 3-liter in-line 6-cylinder engine. An internal combustion engine was run at a speed of 2000 rpm. As shown by the curve L1 in FIG. 5, the air-fuel ratio of the engine was controlled such that the λ value (excess air factor) alternates between 0.9 and 1.1 at a frequency of 4.16 Hz. The temperature of the gas sensor element was kept at 750 degrees C. The curve L2 in FIG. 5 shows temporal variation of the measured output of the gas sensor. The ratio of the variation rate of the output of the gas sensor to the variation rate of the air-fuel ratio was estimated as the gain of the gas sensor.

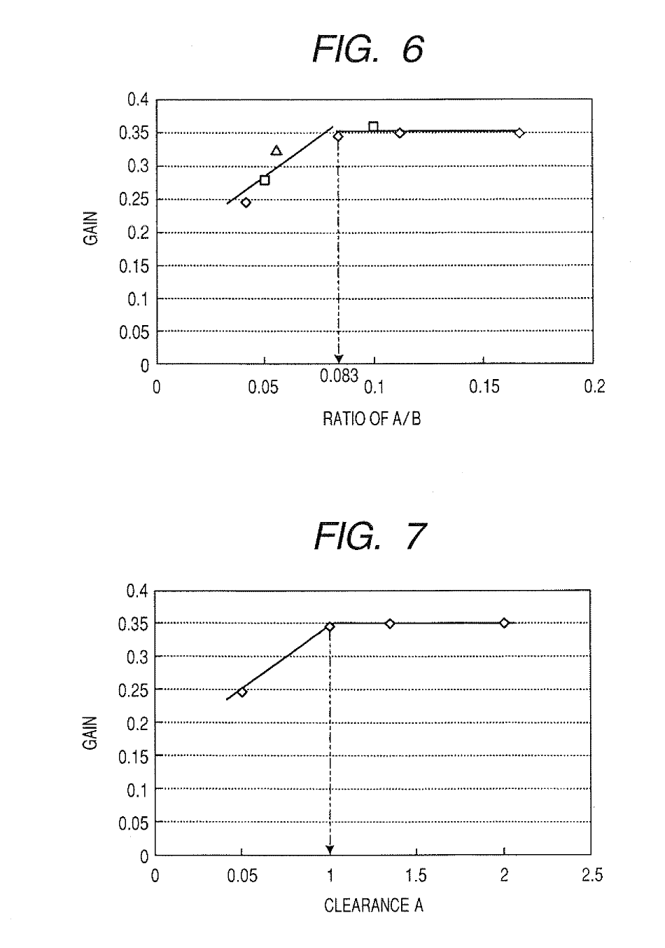

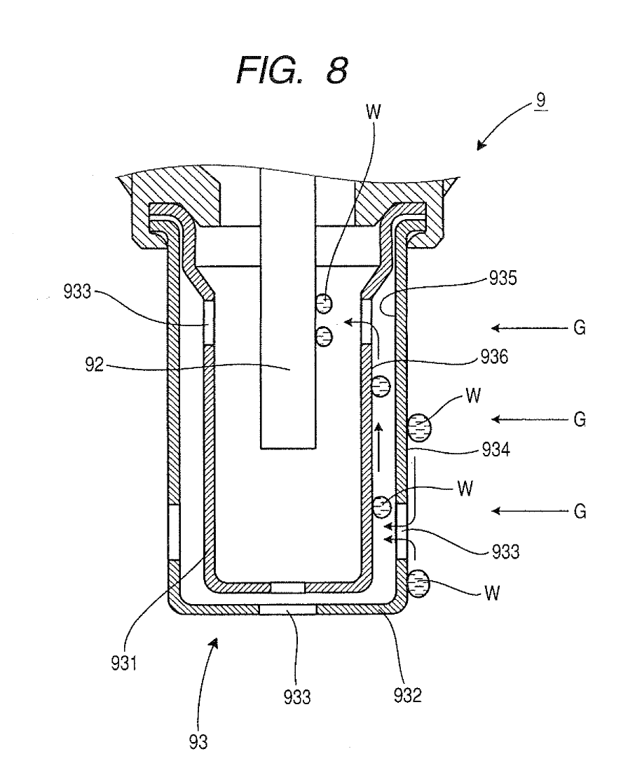

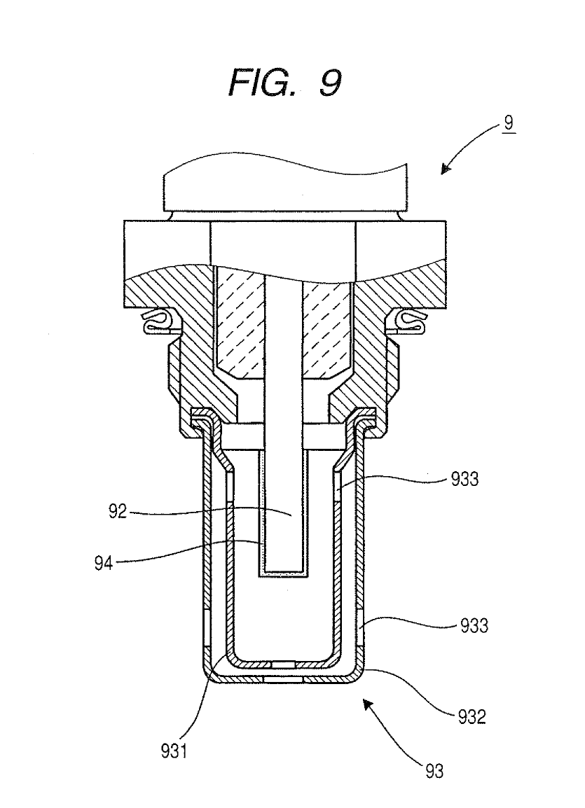

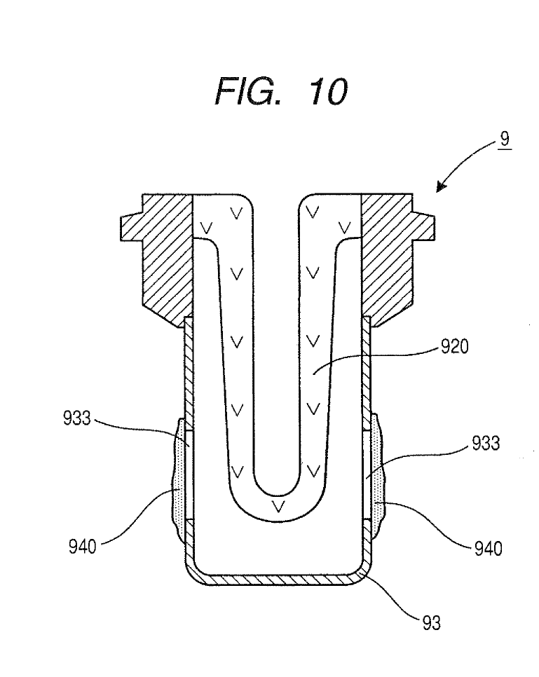

FIG. 6 shows measurements of the gains of the seven gas sensors. In FIG. 6, the marks Δ show measured gains in case of B being 9 mm, the marks □ show measured gains in case of B being 10 mm, and the marks [symbol] show measured gains in case of B being 12 mm. As seen from FIG. 6, if A/B is equal to or larger than 0.083, the gain of the gas sensor (and accordingly the response speed of the gas sensor) is sufficiently high, while on the other hand, if A/B is smaller than 0.083, the gain of the gas sensor decreases with the decrease of A/B. Accordingly, it is preferable to set A/B at a value equal to or larger than 0.083.

FIG. 7 shows measurements of the gains of four of the seven gas sensors, which have the inner diameter B of 12 mm. As seen from the FIG. 7, if A is equal to or larger than 1 mm, the gain of the gas sensor is sufficiently high. Accordingly, it is preferable to set A at a value equal to or larger than 1 mm in terms of response speed of the gas sensor.

The present invention is applicable to an air-fuel sensor mounted on an exhaust pipe of an internal combustion engine of a vehicle to perform exhaust gas feedback control, an O₂ sensor for measuring an oxygen concentration of an exhaust gas, a Nox sensor used for detecting degradation of a ternary catalyst provided in an exhaust pipe to measure concentration of NOx as atmospheric pollutant, etc.

The above explained preferred embodiments are exemplary of the invention of the present application which is described solely by the claims appended below. It should be understood that modifications of the preferred embodiments may be made as would occur to one of skill in the art.

What is claimed is:

1. A gas sensor comprising:
a gas sensor element for measuring a concentration of a specific gas contained in a measurement gas;
a housing through which said gas sensor element is inserted in a longitudinal direction of said gas sensor; and
an element cover fixed to a front end portion of said housing;
said element cover including an inner cover and an outer cover located around said inner cover,
said outer cover being formed with a plurality of outer openings at a side surface thereof, and including a front end portion formed with a discharge opening, said discharge opening being located more closely to a front end side of said gas sensor than said outer openings,
said inner cover being formed with a plurality of inner openings at a side surface thereof, said inner openings being located more closely to said front end side of said gas sensor than said outer openings,
an opening direction of each of said inner openings extending from an inner side to an outer side of said inner cover having a direction component extending in said longitudinal direction towards a base end side of said gas sensor,
wherein, when a clearance between said outer and inner covers at a longitudinal position of said outer openings is A, and an inner diameter of said outer cover at said longitudinal position is B, a ratio of A/B is equal to or larger than a predetermined value.

2. The gas sensor according to claim 1, wherein said predetermined value is 0.083.

3. The gas sensor according to claim 2, wherein said clearance is larger than 1 mm.
